(19) United States
(12) Patent Application Publication
(10) Pub. No.: US 2015/0240571 A1
(43) Pub. Date: Aug. 27, 2015

(54) Connection Assembly

(71) Applicant: Christopher James BOWLES, Bradwell Norfolk (GB)

(72) Inventor: Christopher James Bowles, Bradewell (GB)

(21) Appl. No.: 14/424,333

(22) PCT Filed: Aug. 23, 2013
(86) PCT No.: PCT/EP2013/067581

§ 371 Date: Feb. 26, 2015

(30) Foreign Application Priority Data
Aug. 31, 2012 (GB) 1215526.3

(51) Int. Cl. E21B 17/042; F16L 15/08; E21B 19/16; F16L 15/04

(52) U.S. Cl. CPC E21B 17/0423; F16L 15/04; F16L 15/08; E21B 19/16; F16L 2201/40

(57) ABSTRACT

A connection assembly, for connecting a tool to a tube, having a top sub-assembly that can be passed over a tube, a gripper to grip the outside of a tube when compressed, a sealing ring, adapted to seal against the end face of the tube, a bottom sub-assembly having an abutment face for the sealing ring; and where the two sub-assemblies can be held together to trap the gripper between them. A method for joining a connection assembly to the end of a tube by locating a top sub-assembly around the tube; abutting a sealing ring between the end face of the tube and a bottom sub-assembly; locating a gripper around the tube between the two sub-assemblies and applying a compressive load to them to effect a seal between the tube and the bottom sub-assembly, and to cause the gripper to grip the outer surface of the tube.

### FIELD OF THE INVENTION

The invention relates to a connection assembly for connecting down-hole tools to tubes, especially for use in the drilling industry, for example in the oil and gas industry. More particularly, the invention relates to external grapple connectors. The invention also relates to methods for joining a connection assembly to a tube.

### BACKGROUND TO THE INVENTION

In the drilling industry, and in particular for oil and gas, underground operations are often carried out by affixing tools and the like to the end of tubes, through which material can flow. The tubes used are often so-called “coil tubing” usually made of steel, and that are stored as a coil of material that can be uncoiled for use. In order to attach such tools to the end of the tube, a connector is required. Two forms of connector are common: those that connect to the inside diameter of the tube (Inline Connectors) and those that connect to the outside diameter of the tube (Outline Connectors). Inline connectors have the advantage that there is no increase in the outside diameter of the coil tubing by use of the connector, but with the disadvantage that the bore is restricted, leading to a smaller flow through the tube once the connector is in place. Outline (or grapple) connectors have the advantage that they do not restrict the bore of the tube following connection, although the increased outside diameter of the assembly can restrict their use in some circumstances. The present invention relates only to external/outline grapple connectors.

Such grapple connectors are fixed on to the outside diameter of the coil tubing at the end of the coil tubing reel and are used to attach and run (deploy) what is known in the industry as a Bottom Hole Assembly (BHA), which is a screwed-together combination of pressure-operated tools, such as: jarring subs, hammers, back pressure valves, and milling bits, (called a tool string). This is used to carry out live oil or gas well intervention work, e.g. descaling, fishing out of well trapped/broken equipment, and milling/drilling operations.

Existing coil tubing grapple connectors typically consist of a three-piece assembly and follow a common installation process. The three components are: a threaded compression nut/cap with internal taper; a heat-treated (surface-hardened) tapered grapple spiral teeth slip; and a bottom sub housing that contains the pressure retaining ‘O’-ring seal arrangement.

The installation method involves sliding the connector's threaded compression nut/cap and the (surface hardened) tapered grapple spiral teeth slip over and up the tubing, followed by the bottom sub containing the ‘O’-ring seals, which is tapped on to the end of the tubing until it passes the ‘O’-ring seal area and bottoms out inside the housing. The compression nut/cap is then slid down the tube over the grapple spiral teeth slip and is joined on to the bottom sub housing thread by manually tightening down the threaded compression nut/cap with a spanner or wrench while simultaneously holding the bottom sub housing from rotating by using a second spanner or wrench. This compresses, via the taper, the grapple teeth slip on to the outside of the coil tubing to form the grip.

There are three fundamental areas that determine the success and reliability of current grapple connector design:

1: The grapple slip spiral teeth bites in to the coil tubing to provide tensile and torsion capabilities and prevent the grapple from being pulled from the tube or being rotated in the same direction as the spiral (necessary for rotating tools milling/drilling tools—these all typically rotate clockwise).

2: The two o-ring elastomer seal arrangement housed inside the connector's bottom sub housing—this is essential for a pressure-tight seal to prevent pressure drop when pumping the necessary fluids through the coil tubing to operate the BHA when carrying out operations.

3: The installation procedure for the connector to ensure the tensile and torsion capabilities meet operational requirements and a pressure tight seal is achieved.

Existing Coil Tubing Grapple Connectors are prone to operational problems because of inconsistency with the installation process, which can lead to the connector slipping on the tubing and/or strangulation and collapse of the tube resulting in reduced sealing capability. Once installed, Grapple Connectors are expected to withstand upward and downward jarring (hammer action) with accelerated impacts of several 100,000 lbs force (445 kN) and torsional forces of around 5,000 ft.lbs (6780 Nm) (dependent on tubing strength) during fishing/trapped in hole operations, with single straight pull loads at surface equivalent to 80% of tubing yield.

Existing external coil tubing grapple connectors generally use two elastomer seals (‘O’-rings) when installed to seal against the outside of the coil tubing and can be prone to sealing failure while under pressure causing fluid leaks and, notably, loss of operating pressure (typical internal coil tubing pressure 5,000 psi (34.5 MPa)). The current problems with existing designs have been around for many years and are now inherent with grapple connector use. For example, there are several different brands of grapple connectors all with varying join-up threads and different tapered grapple slips rendering the installation of each connector unique to its own brand, i.e. the amount of turns required to set the grapple on the tube, the position of the o-ring seals and, ultimately, the effectiveness of o-ring seals in this application after considering standard coil tubing is produced with surface finish and tolerances that do not have to comply with British Standard o-ring sealing specifications (BS 1806:1989). In addition, the tubing suffers ovality, nicks and abrasions, and other surface damage during its production and during operations being reeled on and off the coil tubing drum rendering the tubing surface in many instances unsuitable for a pressure retaining o-ring seal.

It is amongst the objects of the present invention to attempt a solution to these problems.

### SUMMARY OF THE INVENTION

Accordingly, in a broad aspect, the invention provides a connection assembly, for connecting a tool to a tube, said assembly comprising: a top sub-assembly having an aperture therethrough to allow it to be passed over a tube; a gripper configured to pass over a tube in a first configuration, and to grip the outside of a tube in a second configuration when a compressive force is applied thereto; a sealing ring, adapted to seal against the end face of the tube; a bottom sub-assembly having an abutment face for forming a seal against the end face of the tube; and wherein said top and bottom sub-assemblies are adapted to be releasably held together to trap said gripper therebetween. In preferred embodiments said assembly further comprises a seal arrangement interposed between said abutment face and the end face of the tube. Such a seal arrangement might comprise a gasket or a sealing ring, or an applied ring of a sealing compound such as a paste, grease or a polymeric composition. Suitable materials for such a sealing ring would include graphite, soft iron, copper, Stainless steel, nickel-chromium alloys such as those sold under the Registered Trade Mark “Inconel”, metal (generally), hollow rings, and gas filled rings. The inventor has found that Aluminium, and alloys thereof, is a particularly suitable material for the sealing rings. Particularly preferred embodiments of seal arrangements are described below. Such a seal arrangement might also comprise a modification of said abutment face, for example by provision of a more malleable portion of an abutment face by incorporating a ring of softer material into the abutment face.

Said gripper could comprise a deformable polymeric sleeve, although it is preferred that said gripper comprises a collet, and more preferably said collet is provided with inwardly-facing teeth.

Where a collet is used, it is preferred that said collet is provided with outwardly-facing tapered portions such that and axial compressive force applied thereto is transmitted into a radial compressive force. As compressive force is applied to the collet it deforms to grip the outside surface of the tube.

Preferably, the wall of said collet has through-slots extending from alternate ends of the collet. Such an arrangement allows stresses within the collet to be more evenly distributed around it, thereby reducing the likelihood of mechanical failure. In any aspect, the collet is preferably reversibly deformable.

In any aspect of the invention it is preferred that said top sub-assembly comprises a top-sub assembly body having an internal buttress thread adapted to receive a collet having a corresponding external buttress thread. The interaction between the two buttress threads as the collet is subjected to a compressive load ensures that it deforms inwardly to grip the outside surface of the tube.

Also in any aspect of the invention it is preferred that said top sub-assembly body is provided with a window aperture to allow visualisation of a gripper located within said top sub-assembly. This allows an operator to check that the gripper is functioning as intended whilst the assembly is in use.

Preferably, said connection assembly further comprises a top sub-assembly lock nut attachable to said top sub-assembly body and having a stop face that may be moved in an axial direction relative to said top sub-assembly body to abut a gripper located within said top sub-assembly body. The use of a lock nut in this fashion ensures that the collet is unable to exert greater force on the outside of the tube that that used in the installation operation (to be described below), thereby preventing damage to the tube (e.g. necking).

Preferably in the connection assembly said bottom sub-assembly comprises a bottom sub-assembly body having an external connector to receive a tool to be attached to the connection assembly.

Also in any aspect of the invention said bottom sub-assembly comprises a bottom sub-assembly body and seal ring housing locatable at least partly therein. More preferably, said seal ring housing and bottom sub-assembly body are provided with cooperating respective external and internal tapered surfaces. In further preferred variants, said seal ring housing is further provided with an internal ‘O’-ring groove adapted to seal an ‘O’-ring to an external surface of a tube. This provides a back-up seal in case of compromise to the end-face seal. In a yet further preferred variant, said seal ring housing is further provided with an external ‘O’-ring groove adapted to seal an ‘O’-ring to an internal surface of the bottom sub-assembly body.

In any aspect of the connection assembly, it is preferred that said sealing ring is metal, and more preferably hollow. For metal rings, copper (and especially annealed copper) or Aluminium (or alloys thereof) is preferred, or for situations where hydrogen sulphide is present, malleable cast iron. The sealing ring may, in preferred variants, be hollow, and filled with a filler such as asbestos or an inert gas. It is also preferred that the bore of the sealing ring is no larger than the bore of the coil tube to which the connector is to be attached. It is especially preferred that the sealing ring is configured such that no part of the ring extends, in use, into the bore of the coil tube to which the connector is to be attached. These configurations ensure that the internal flow path within the tube is not obstructed by the connector assembly and its associated seals.

Also included within the scope of the invention is a collet for use in a connection assembly described herein, said collet comprising a cylinder having internal grip teeth, an external buttress thread, and a plurality of through-slots said slots extending sequentially from alternate ends of the collet.

Also included in the scope of the invention is a method of joining a connection assembly to the end of a tube, said method comprising the steps of: locating a top sub-assembly around said tube; abutting the end face of said tube with a bottom sub-assembly; locating a gripper around said tube between said top sub-assembly and said bottom sub-assembly; applying a compressive load to said top and bottom sub-assemblies in a direction generally parallel to the longitudinal axis of the tube to effect a seal between the tube and the bottom sub-assembly, and to cause said gripper to grip the outer surface of the tube; holding said top and bottom sub-assemblies together, thereby trapping said gripper between the top and bottom sub-assemblies; removing said compressive load. In preferred embodiments, a seal arrangement, as described herein, is interposed between the end face of the tube and an abutment face of said bottom sub-assembly.

Preferably, said compressive load is monitored. In this way, the connection may be made in a consistent manner, thereby increasing the safety and security of the attachment. More preferably, said compressive load is controlled to be less than the compressive yield strength of the tube. In this way, the strength of the attachment may be optimised without a risk of compromising the integrity of the tube, e.g. by exceeding its crush strength.

Also included within the scope of the invention is a seal ring housing, for use in an assembly or method described herein, said seal ring housing being generally cylindrical, having an aperture therethrough, the bore of said housing being provided with a step forming a seal-engagement face.

Included within the scope of the invention is a method, connection assembly, seal ring housing or collet substantially as described herein with reference to an as illustrated by any appropriate combination of the accompanying drawings.

### BRIEF DESCRIPTION OF THE DRAWINGS

The invention will be described with reference to the accompanying drawings, in which:

FIGS. 1 to 4 schematically illustrate apparatus and a method for connection of a connector to the end of a tube;

FIGS. 5-8 illustrate elements of a top sub-assembly of a connector;

FIGS. 9-14 illustrate elements of a bottom sub-assembly of a connector;

FIGS. 15-17 illustrate a collet;

FIG. 18 illustrates a hydraulic jig for use in a method of the invention;

FIGS. 19-25 illustrate stages in a method of the invention.

### DETAILED DESCRIPTION OF THE INVENTION

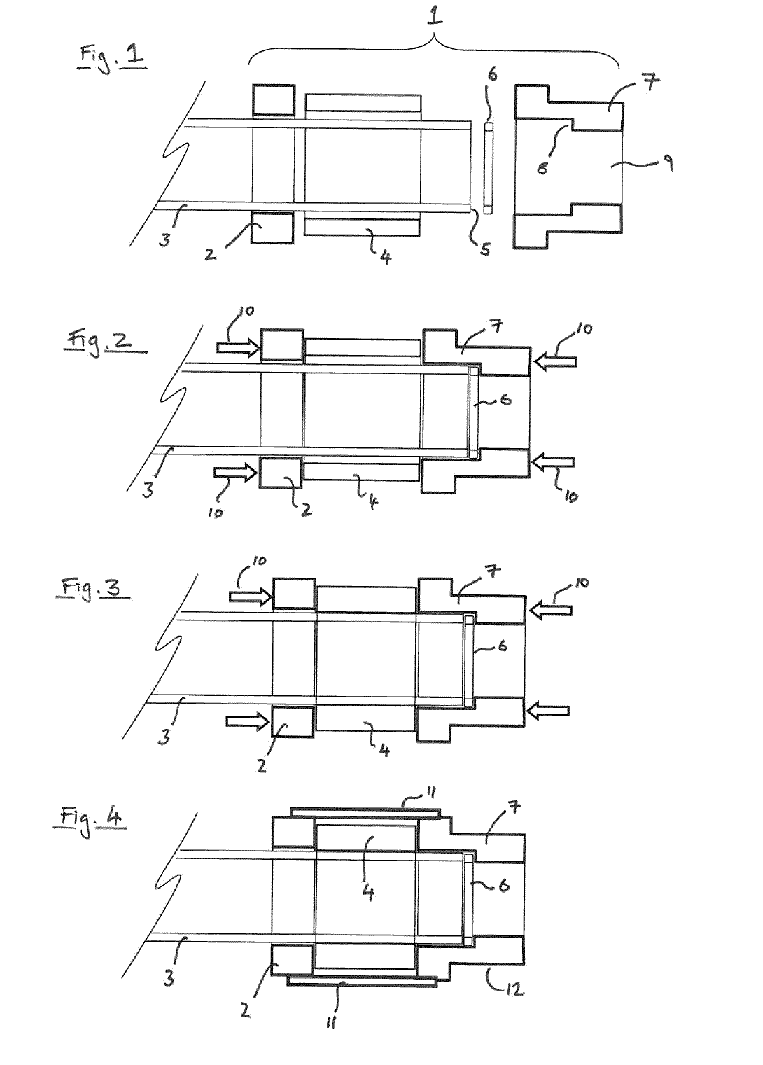

FIGS. 1 to 4 illustrate, in schematic sectional form, an embodiment of the method and apparatus of the present invention. A connection assembly, generally indicated by 1, comprises a top sub-assembly 2, a gripper 4, a sealing ring 6 and a bottom sub-assembly 7. The top sub-assembly is of generally cylindrical form, having an aperture therethrough to allow it to be located around a tube 3 to which the connection assembly 1 is to be joined. The gripper 4 is similarly located around the tube 3 between the top sub-assembly 2 and the end face 5 of the tube 3. The sealing ring 6 is abutted to the end face 5 of the tube. The bottom sub-assembly 7 is located (as can be better seen in FIG. 2) at the end of the tube 3, the bottom sub-assembly 7 having a seal-engagement face 8 to hold the sealing ring 6 against the end face 5 of the tube 3.

The sealing ring 6 and bottom sub-assembly 7 are provided with an aperture 9 therethrough of the approximate size of the internal bore of the tube 3, so as not to restrict flow of material through the tube 3 when the assembly is in operation. It is preferred that the bore of the sealing ring is no larger than the bore of the coil tube to which the connector is to be attached, and especially preferred that the sealing ring is configured such that no part of the ring extends, in use, into the bore of the coil tube to which the connector is to be attached. These configurations ensure that the internal flow path within the tube is not obstructed by the connector assembly and its associated seals.

The controlled and even forces exerted by the connector on a tube to which it is attached reduce the risk of collapse or other deformation of the tube. As a result, no internal support liner is required within the bore of the tube, which would otherwise restrict the flow within the tube and connector, in use.

Referring the FIG. 2, once the connection assembly 1 is located on the end of the tube 3, a compressive load is applied to the assembly 1, indicated by the arrows 10. As the load is applied, the gripper 4 deforms to a second configuration, shown in FIG. 3, such that it grips the outer surface of the tube 3. The compressive load also causes the sealing ring 6 to effect a seal between the bottom sub-assembly 7 and the end face 5 of the tube 3.

Whilst in the compressed configuration, the bottom sub-assembly 7 is connected to the top sub-assembly 2, holding them at a fixed distance apart, to trap the gripper between the two assemblies 2, 7 and thereby maintain it in its tube-gripping configuration. In this schematic embodiment, the bottom sub-assembly 7 is connected to the top sub-assembly by means of a connector 11. In other embodiments illustrated below, the connection between the two sub-assemblies 2, 7 may be made by means of a screw thread.

Once the connection assembly 1 has been attached to the end of a tube 3, it may be used to connect tools (not illustrated) as required to the end of the tube. This may be effected, for example, by the provision of a screw thread on the outside surface 12 of the bottom sub-assembly 7.

The connection assembly may be removed from the end of the tube by reversing the process: a compressive load is again applied, the two sub-assemblies are disconnected from each other, and the compressive load is removed. Where a reversibly-deformable gripper 4 is employed (which is preferred), the elements of the connection assembly 1 may then be removed from the tube 3.

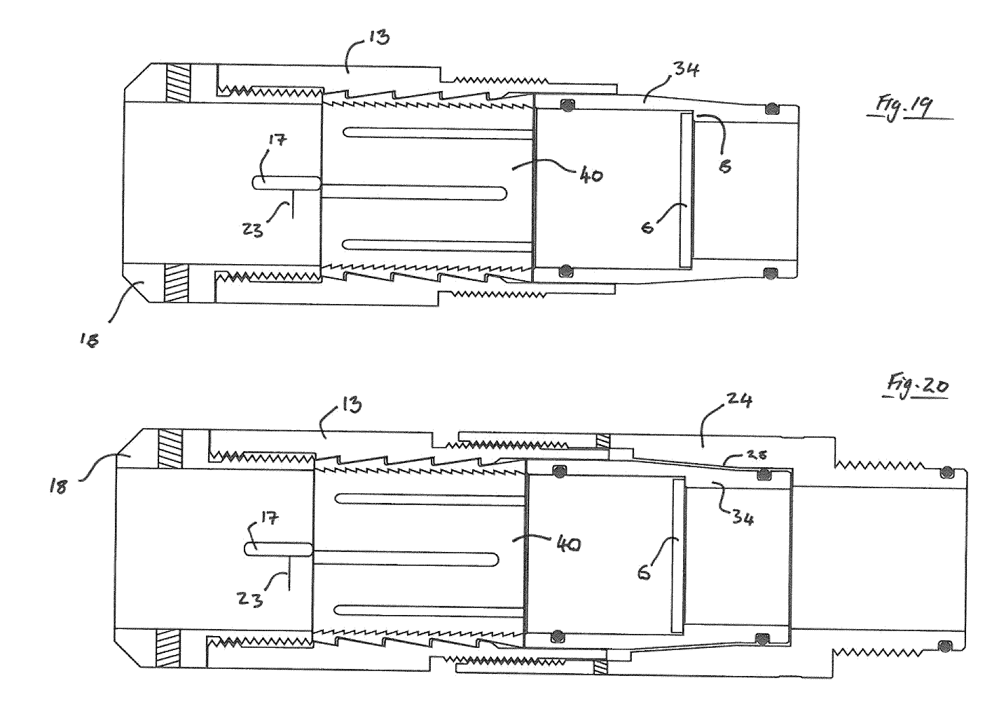

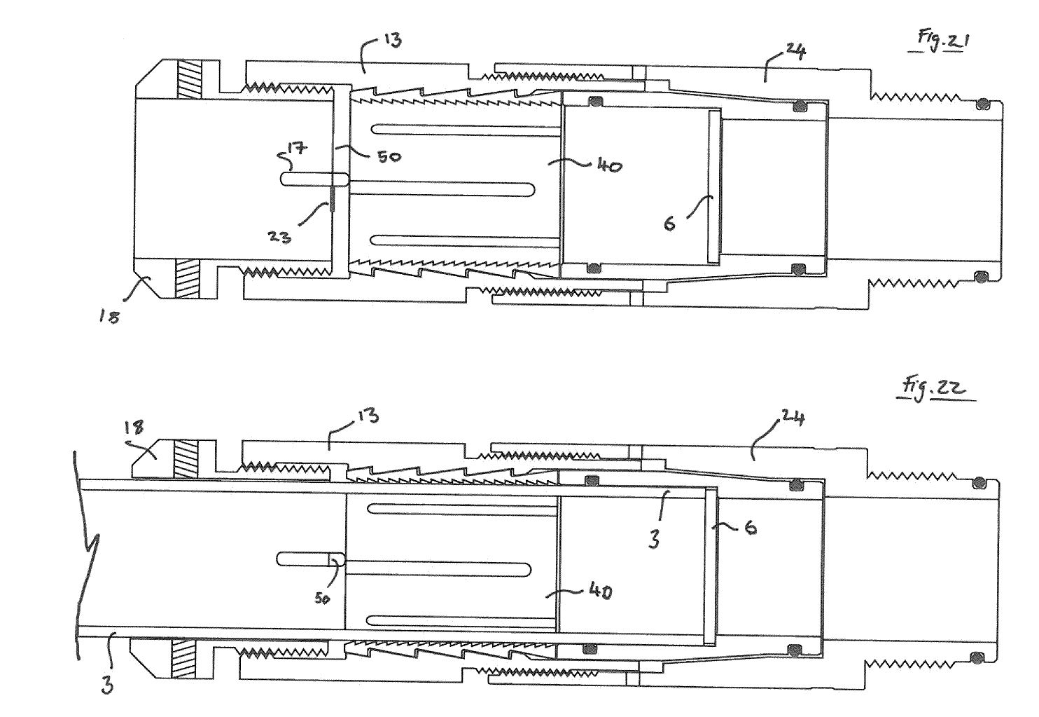

A further embodiment of the apparatus of the invention is now described with reference to FIGS. 5-25. In this embodiment, the top- and bottom sub-assemblies are both multi-component. The use of either, or both, such a configuration of sub-assemblies and the particular features described herein brings further advantages, that will be described.

In this specification, the terms “top sub-assembly” and bottom sub-assembly” are used interchangeably with the terms “top-sub” and “bottom-sub” respectively for sake of brevity. The top sub-assembly refers to the part of the connection assembly furthest from the end of the tube to which the assembly is connected and the bottom sub-assembly is the part nearest the end of the tube.

FIG. 5 illustrates, in cross-sectional view, a top sub-assembly body 13 for use as part of a top sub-assembly 1. The top sub-assembly body 13 is of generally cylindrical form, having a through aperture of diameter to allow it to surround a tube on which it is to be used. The top-sub body 13 has an external thread 14 to allow it to be connected to a bottom sub-assembly (24 and 34), illustrated below. The bore 19 of the top-sub body 13 is provided with a coarse internal gripper thread 15 to engage an externally-threaded gripper, illustrated below. The shallow incline of the internal gripper thread 15 provides the means to cause the applied compressive load to urge the gripper into gripping engagement with the outside of the tube.

An internal lock-nut thread 16 is provided at one end of the top-sub body to allow attachment of a top-sub lock nut 18. A window 17 is provided through the wall of the top-sub body to allow visualisation of the movement of a gripper 4, 40 within the top-sub. In this embodiment, the window 17 is elongate, with rounded ends. The use of such a shape minimises the chance of stress cracks, and provides minimum compromise to the structural strength of the body.

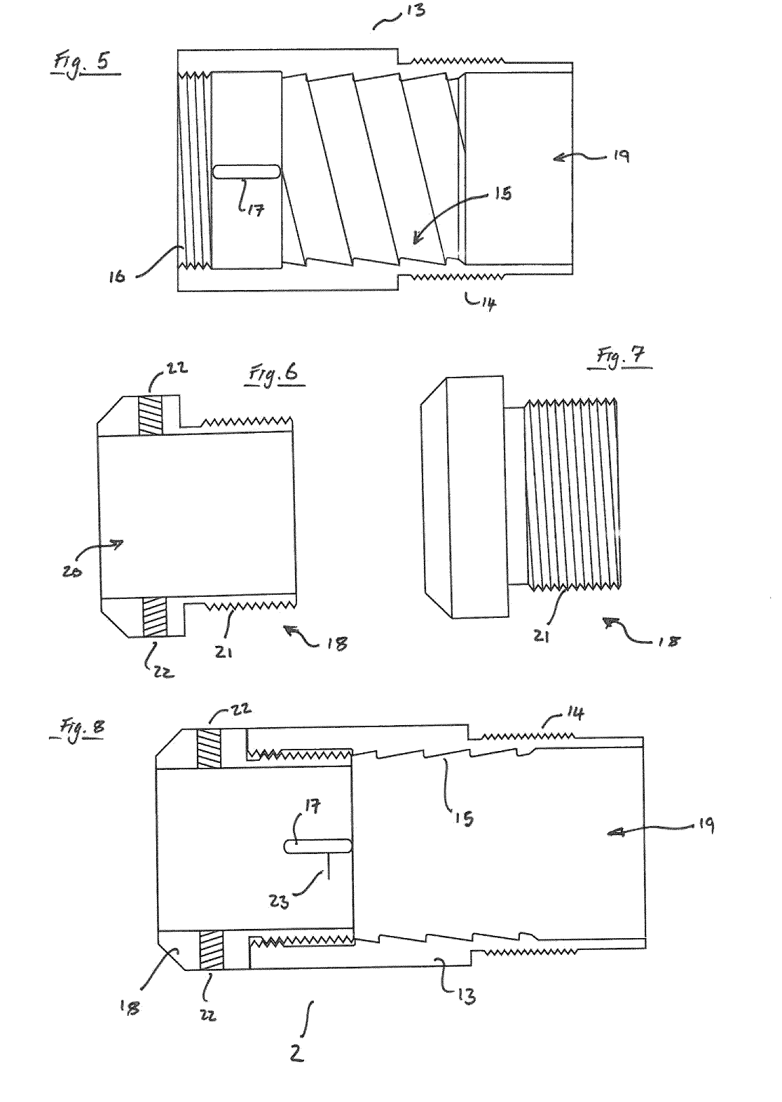

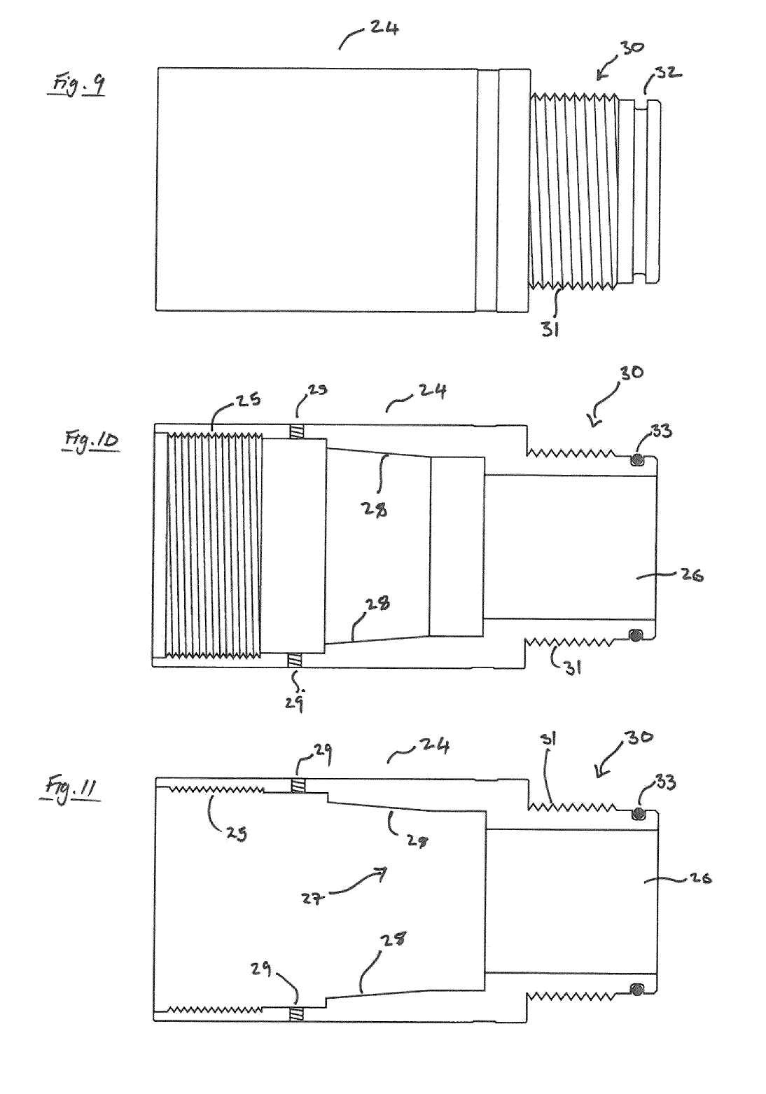

FIGS. 6 and 7 illustrate, in cross-section and elevation views respectively, a top-sub lock nut 18. The lock nut 18 is again of generally cylindrical form, having a through aperture 20 to allow it to pass over the outside of a tube to which the connection assembly 1 is to be fitted. The top-sub lock nut 18 has an external thread 21 to allow it to engage with the internal lock nut thread 16 of the top-sub body 13. Radial threaded holes 22 are provided through the wall of the top-sub lock not 13 to allow grub screws (not illustrated) or the like to be used to provide additional securing to a tube. Such threaded holes and associated grub screws are useful for securing the top-sub lock nut to the tube, but are not essential. In fact, for some applications, it is preferable not to use the grub screws, as there is a small risk that they can damage the outside surface of the tube.

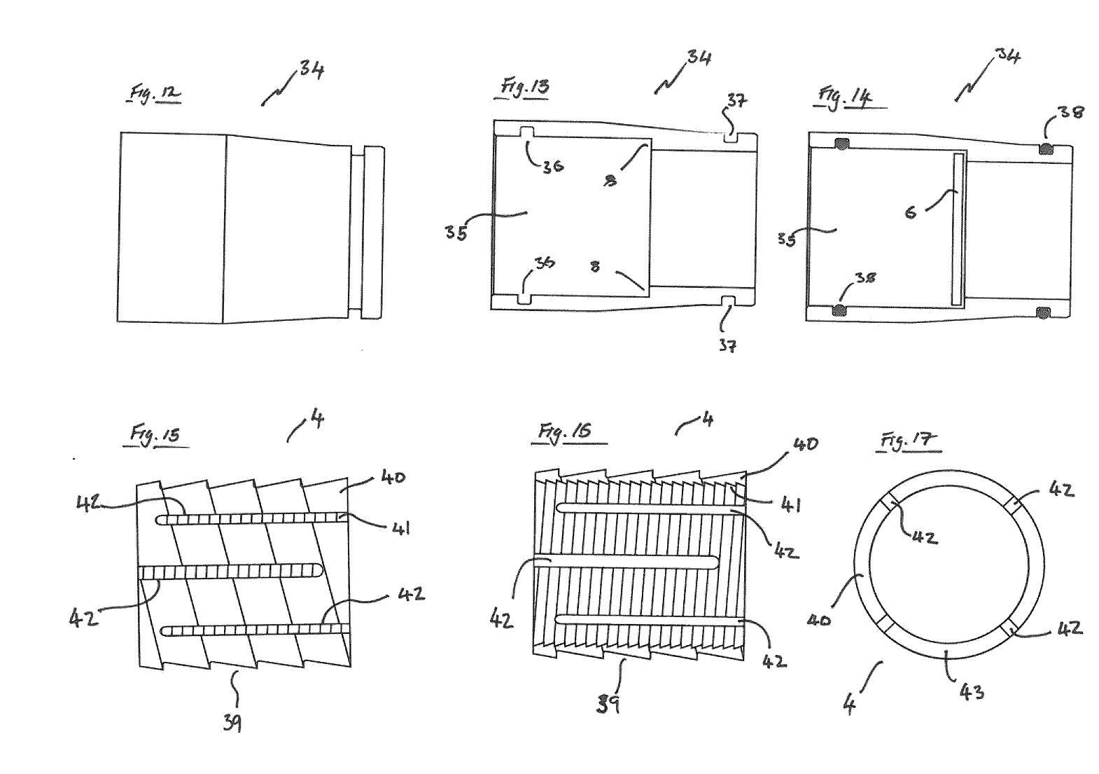

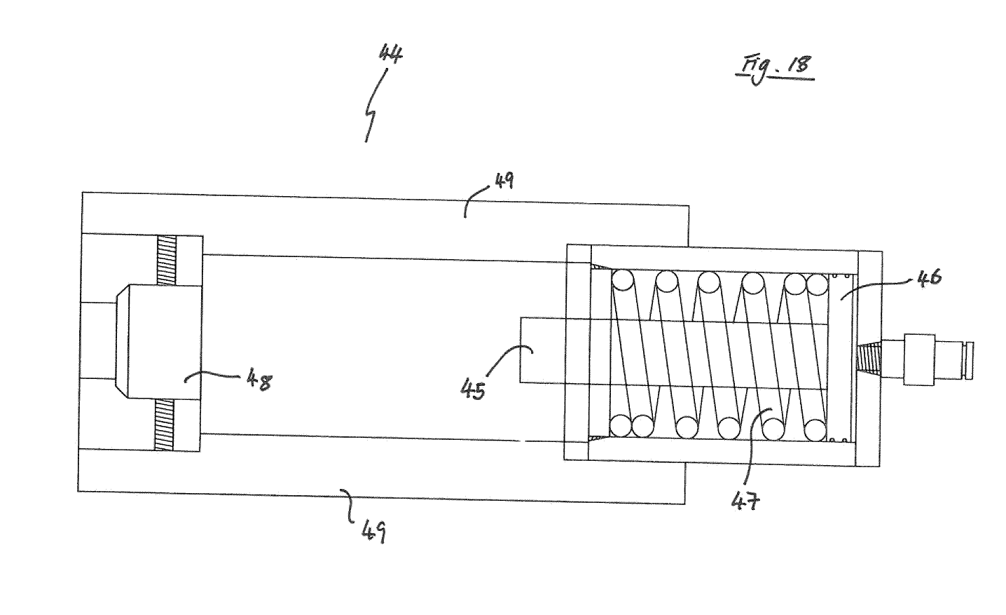

FIG. 8 illustrates the top-sub body 13 and top-sub lock nut 18 connected to form a top sub-assembly 2. On the external face of the top-sub body 13 is provided an indicium 23 adjacent the window 17. In this embodiment, the indicium has the form of a line (for example, a shallow groove) parallel to the circumference of the tube. Other indicia, such as an arrow, could be employed. The indicium is used to check the position of the gripper 4, as will be described below.

FIGS. 9, 10 and 11 illustrate in elevation and cross-sectional view, a bottom sub-assembly body (“bottom-sub body”) 24 forming, in conjunction with a seal ring housing 34 described below, a bottom sub-assembly 7.

The bottom-sub body 24 is of generally cylindrical form. An internal thread 25 is provided at one end to allow connection with the external thread 14 of a corresponding top-sub body 13. Located within the bore 26 of the bottom-sub body is recessed region 27 to accommodate a seal-ring housing 34. The walls of this region 27 are provided with a tapered portion 28, preferably in the form of a Morse taper, to engage a similarly shaped external face of the seal-ring housing 34.

Threaded holes 29 are also provided through the wall of the bottom-sub body to allow grub screws (not illustrated) or the like to be used to provide an additional securing between the top-sub and the bottom-sub of the connection assembly.

At the opposite end of the bottom-sub 24 to the internal thread 25 is located a connector region 30 to provide a connection for a tool or the like to be attached to the tube 3 via the connection assembly 1. In this embodiment, an external tool thread 31 is provided, together with an ‘O’-ring groove 32 to accommodate an ‘O’-ring 33 to provide a seal between the bottom sub 24 body and a tool or the like.

FIGS. 12-14 illustrate, in elevation and cross-sectional view, a seal ring housing 34, forming part of a bottom sub-assembly 7. The seal ring housing 34 is generally cylindrical in form, having an aperture therethrough. The bore 35 of the seal ring housing 34 is provided with step forming a seal-engagement face 8, against which a sealing ring 6 may be abutted. On one side of the face 8, the internal diameter of the seal ring housing 34 is sufficient to accommodate the external diameter of a tube 3 that is to be used. An internal ‘O’-ring groove 36 may be provided in this region to provided a secondary fail-safe seal between the outside surface of a tube and the inside of the seal-ring housing. On the other side of the face 8, the internal diameter of the seal ring housing is approximately the same as the internal diameter of the tube that is to be used. In this way, there is no restriction to flow through the connection assembly.

On the outside wall of the seal ring housing 34 there is provided a taper, and preferably a Morse taper, to cooperate with the recessed region 27 of the bottom-sub body 24.

Also on the outside of the wall of the seal ring housing 34 there is provided a further external ‘O’-ring groove 37 to provide a seal between the seal ring housing and the bottom sub body. ‘O’-ring groove 36 provides a back-up seal in the unlikely event that the seal between the sealing ring 6 and the end face 5 of the tube 3 is compromised. Both ‘O’-ring grooves 36, 37 may be provided with appropriate ‘O’-rings 38.

FIGS. 15-17 illustrate, in elevation, axial cross-section and radial cross-section respectively, a gripper 4 in the form of a collet 40. The collet 40 is of generally cylindrical form having an aperture therethrough to allow the collet 40 to be passed over the outside of a tube on which it is to be used. The external surface of the collet 40 is provided with a large pitch helical thread 39 having asymmetric thread angles forming a buttress thread.

The bore of the collet 40 is provided with inwardly-facing gripping members 41 that, in this embodiment, take the form of helically-disposed grip teeth. The collet is made from a deformable strong material such as surface hardened steel. The collet is preferably made from a resiliently deformable material, to assist in removing the collet 40 from a tube when it is no longer required.

Longitudinal slots 42 are provided in the collet, extending completely through the wall 43 in the radial direction and extending from one end of the collet to a position adjacent the other end. In preferred embodiments successive slots in the collet extend from alternate ends. The inventor has found that such an arrangement prevents asymmetric deformation of the collet when compressed, and thereby improves the grip on the tube 3, and reduces internal stresses in the apparatus. In particularly preferred embodiments, eight such slots 42 are provided—four extending from one end of the collet 40 and four extending from the opposite end. The number of slots may be chosen depending on the size of the collet, larger collets having more slots to allow the stresses to be distributed around the collet's circumference.

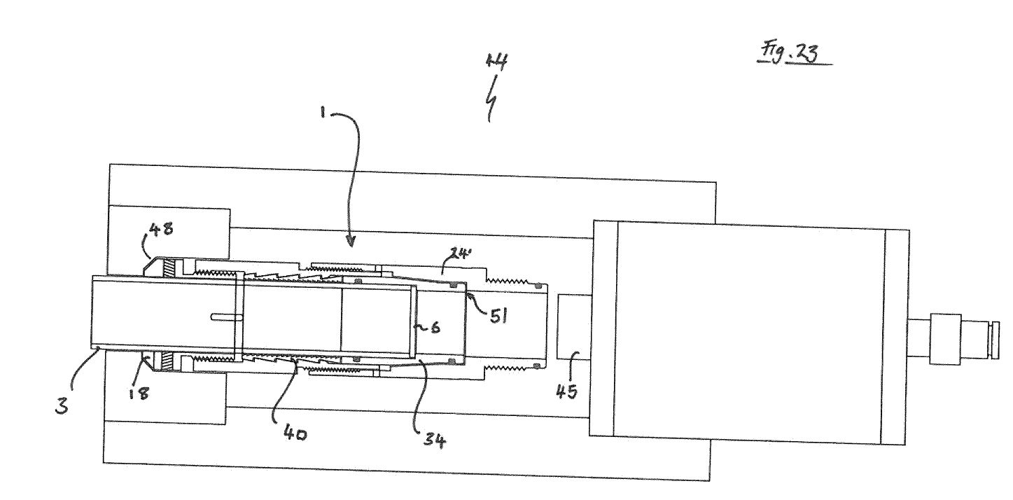

A method for attaching the connection assembly 1 to the end of a tube will now be described. FIG. 18 illustrates in horizontal cross-sectional view a hydraulic assembly jig, generally illustrated by 44, that may be used to attach a connection assembly 1 to the end of a tube 3. The jig comprises a hydraulic ram 45 actuated by delivering high pressure hydraulic fluid to a face of a piston 46. On release of the hydraulic pressure, the ram 45 returns to its at-rest position by means of a biasing spring 47. The hydraulic ram 45 is held apart from a top-sub receiving support 48 by two arms 49. The top-sub receiving support 48 may be configured to be removable such that different-sized top-sub receiving supports may be provided to suit a variety of sizes of connector and tubes. Similarly, the hydraulic ram 45 may be configured (e.g. by having a replaceable threaded portion) to accommodate a range of sizes of ram with different outside diameters to suit the diameters of different sizes of tubing.

FIGS. 19-22 illustrate preparation of the connection assembly. In FIG. 19, the top-sub lock nut 18 is screwed fully into the top-sub body 13. The gripper 4, in the form of a collet 40, is screwed into the top sub assembly until it abuts the end of the top-sub lock nut 18. The sealing ring 6 is placed in position on the seal-engagement face 8 of the sealing ring housing 34, and the housing 34 is inserted into the top-sub body 13 until it abuts the collet 40. The bottom sub body 24 is then screwed onto the top sub body until the top sub taper abuts the seal ring housing taper, as illustrated in FIG. 20. The external seal ring housing ‘O’-ring grips the inside of the bottom sub body, and provides a secondary pressure seal.

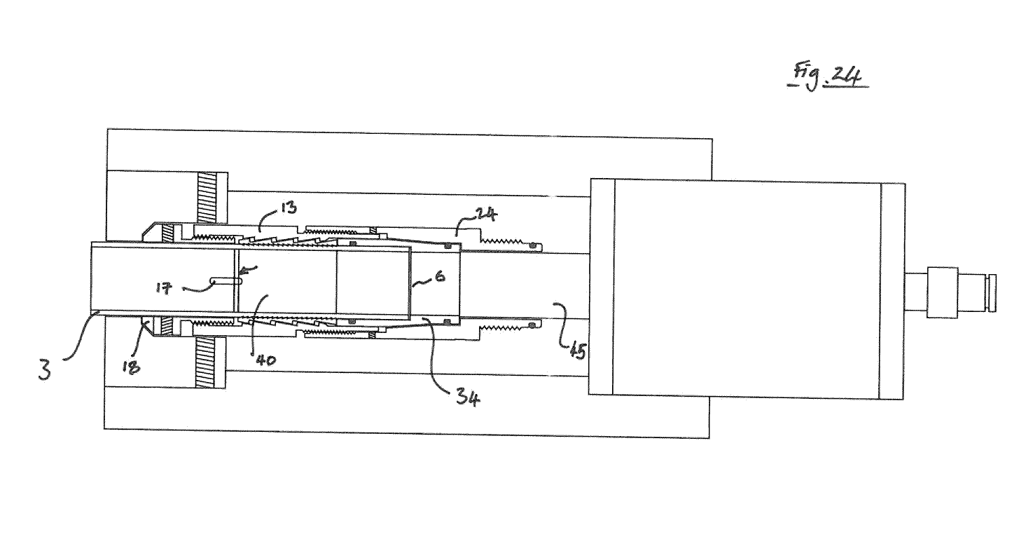

As illustrated in FIG. 21, the top sub lock nut 18 is now unscrewed until its stop face 50, visible through the window 17 in the top-sub body, is aligned with the indicium 23. As illustrated in FIG. 22, the end of the tube 3 is inserted through the top-sub lock nut 18, and through the collet 40 until it abuts the seal ring 6. The internal ‘O’-ring in the seal housing (if fitted) now forms a secondary seal on the tube. At this stage, grub screws (if present) in the lock nut 18 may be used to temporarily hold the assembly in place on the tube.

Turning now to FIG. 23, the connection assembly 1, connected to the end of the tube 3 is located within the jig 44 with the top-sub lock nut 18 seated within the top-sub receiving support 48 of the jig. The hydraulic ram 45 is aligned with the opening in the bottom-sub body, and is so sized as to be able to move within the aperture in the bottom sub body, but to exert force on the end face 51 of the sealing ring housing 34.

The hydraulic ram is actuated, as shown in FIG. 24, to exert a compressive load between the sealing ring housing 34 and the top-sub lock nut 18. The compressive force effects a seal between the end face of the tube 3 and the sealing ring 6. The abutment of the end of the sealing ring housing 34 and the collet 40 urges the collet relative to the top-sub assembly and interaction between the inclined thread regions 39 and 15 of the collet 40 and top sub body 13 respectively cause deformation of the collet such that the internal grip teeth 41 of the collet engage with the outer surface of the tube. As the collet moves within the top-sub body 13, the leading edge of the collet becomes visible thought the window 17 of the top-sub body. This provides a visual indication that the gripper 4 (i.e. the collet 40, in this embodiment) has been actuated. At this stage, the sealing ring housing 34 will have moved within the bottom sub body 24, towards the tube 3. Whilst the compressive load is still applied, the bottom sub body 24 is screwed towards the top sub body. This may be accomplished by use, e.g. of a chain wrench. Alternatively, external flats may be provided on the outer body of the bottom sub-assembly to allow a spanner to be used. Having held the two sub-assemblies together in this way, grub screws on the top-sub body may be tightened to prevent the two sub-assemblies moving apart. The taper on the bottom-sub body is now compressed onto the taper in the seal-ring housing thereby retaining the pressure between the gripper collet 40 and outside surface of the tube 3 once the applied compressive load is released.

The assembly and tube may then be removed from the jig.

During the application of the compressive load, the force exerted by the ram 45 may be monitored to ensure that the applied load remains below the buckling compressive yield strength of the tube 3. In particularly-preferred embodiments pressure control is provided to prevent the applied load exceeding the compressive yield strength of the tube.

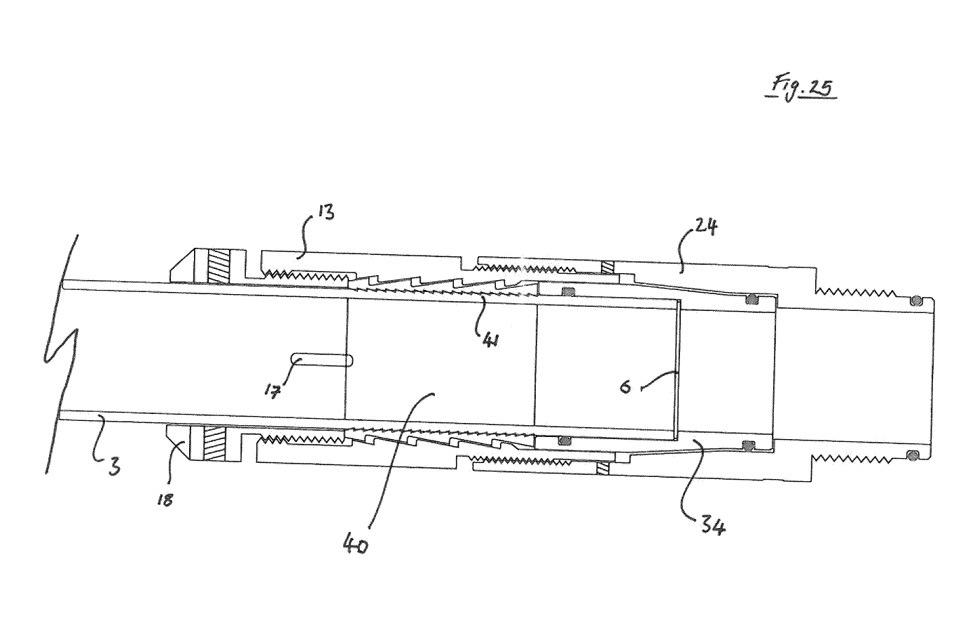

The top-sub lock nut 18 is then screwed into the top-sub body until the lock nut stop face presses on to the gripper collet 40. If used, grub screws in the top-sub lock nut 18 may then be tightened to prevent the lock nut from unscrewing. The abutment of the lock nut stop face with the end of the gripper collet 40 may be viewed through the window 17 in the top sub body. The abutment of the lock nut stop face with the gripper collet ensures that the collet cannot be displaced during subsequent use of the connection assembly and so prevents it from exerting pressure on the tube that might exceed the collapse strength of the tube. The final configuration is illustrated in FIG. 25. It can be seen that the grip teeth 41 of the collet 40 are biting into the outside wall of the tube 3. The abutment of the top sub lock nut 18 with the end of the collet 40 can also be seen through the window 17 in the top sub body 13.

1.-23. (canceled)

24. A connection assembly, for connecting a tool to a tube, the assembly comprising:
a top sub-assembly having an aperture therethrough to allow it to be passed over a tube;
a gripper configured to pass over a tube in a first configuration, and to grip the outside of a tube in a second configuration when a compressive force is applied thereto;
a bottom sub-assembly having an abutment face for forming a seal against the end face of the tube;
a seal arrangement comprising a metal sealing ring interposed between said abutment face and the end face of the tube;
wherein said top and bottom sub-assemblies are adapted to be releasably held together to trap the gripper therebetween.

25. A connection assembly, for connecting a tool to a tube, the assembly comprising:
a top sub-assembly having an aperture therethrough to allow it to be passed over a tube;
a gripper configured to pass over a tube in a first configuration, and to grip the outside of a tube in a second configuration when a compressive force is applied thereto;
a bottom sub-assembly having an abutment face for forming a seal against the end face of the tube;
a seal arrangement interposed between the abutment face and the end face of the tube;
the top and bottom sub-assemblies configured to be releasably held together to trap the gripper therebetween;
wherein the connection assembly does not restrict the bore of a tube following connection.

26. A connection assembly according to claim 24 wherein the gripper comprises a collet.

27. A connection assembly according to claim 26 wherein the collet is provided with inwardly-facing teeth.

28. A connection assembly according to claim 26 wherein the collet is provided with outwardly-facing tapered portions such that an axial compressive force applied thereto is transmitted into a radial compressive force.

29. A connection assembly according to claim 26 wherein the wall of the collet has through-slots extending from alternate ends of the collet.

30. A connection assembly according to claim 24 wherein the top sub-assembly comprises a top-sub assembly body having an internal buttress thread adapted to receive a collet having a corresponding external buttress thread.

31. A connection assembly according to claim 24 wherein the top sub-assembly body is provided with a window aperture to allow visualization of a gripper located within the top sub-assembly.

32. A connection assembly according to claim 29 further comprising a top sub-assembly lock nut attachable to the top sub-assembly body and having a stop face that may be moved in an axial direction relative to the top sub-assembly body to abut a gripper located within the top sub-assembly body.

33. A connection assembly according to claim 24 wherein the bottom sub-assembly comprises a bottom sub-assembly body having an external connector to receive a tool to be attached to the connection assembly.

34. A connection assembly according to claim 24 wherein the bottom sub-assembly comprises a bottom sub-assembly body and seal ring housing locatable at least partly therein.

35. A connection assembly according to claim 34 wherein the seal ring housing and bottom sub-assembly body are provided with cooperating respective external and internal tapered surfaces.

36. A connection assembly according to claim 34 wherein the seal ring housing is further provided with an internal ‘O’-ring groove adapted to seal an ‘O’-ring to an external surface of a tube.

37. A connection assembly according to claim 34 wherein the seal ring housing is further provided with an external ‘O’-ring groove adapted to seal an ‘O’-ring to an internal surface of the bottom sub-assembly body.

38. A connection assembly according to claim 25 wherein the seal arrangement comprises a metal sealing ring.

39. A connection assembly according to claim 24 wherein the sealing ring is hollow.

40. A collet for use in a connection assembly according to claim 26 comprising a cylinder having internal grip teeth, an external buttress thread, and a plurality of through-slots the slots extending sequentially from alternate ends of the collet.

41. A method of joining a connection assembly according to claim 24 to the end of a tube, the method comprising:
locating a top sub-assembly around the tube;
abutting the end face of the tube with a bottom sub-assembly with the seal arrangement interposed between the end face of the tube and an abutment face of the bottom sub-assembly;
locating a gripper around the tube between the top sub-assembly and the bottom sub-assembly;
applying a compressive load to the top and bottom sub-assemblies in a direction generally parallel to the longitudinal axis of the tube to effect a seal between the tube and the bottom sub-assembly, and to cause the gripper to grip the outer surface of the tube;
holding the top and bottom sub-assemblies together, thereby trapping the gripper between the top and bottom sub-assemblies;
removing the compressive load.

42. A method according to claim 41 wherein the compressive load is monitored.

43. A method according to claim 41 wherein the compressive load is controlled to be less than the compressive yield strength of the tube.

44. A method of joining a connection assembly according to claim 25 to the end of a tube, the method comprising:
locating a top sub-assembly around the tube;
abutting the end face of the tube with a bottom sub-assembly with the seal arrangement interposed between the end face of the tube and an abutment face of the bottom sub-assembly;
locating a gripper around the tube between the top sub-assembly and the bottom sub-assembly;
applying a compressive load to the top and bottom sub-assemblies in a direction generally parallel to the longitudinal axis of the tube to effect a seal between the tube and the bottom sub-assembly, and to cause the gripper to grip the outer surface of the tube;
holding the top and bottom sub-assemblies together, thereby trapping the gripper between the top and bottom sub-assemblies;
removing the compressive load.
